(19) United States
(12) Patent Application Publication
(10) Pub. No.: US 2005/0248253 A1
(43) Pub. Date: Nov. 10, 2005

(54) Cathode ray tube

(75) Inventor: Junichi Kimiya, Ibaraki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/125,057

(22) Filed: May 9, 2005

(30) Foreign Application Priority Data
May 10, 2004 (JP) 2004-139981

(51) Int. Cl. H01J 29/50

(52) U.S. Cl. 313/414

(57) ABSTRACT

An electron gun includes an electron beam generating portion for generating electron beams (cathodes K, a G1 electrode and a G2 electrode) and an electron beam focusing portion (a G3 electrode, a G4 electrode, a G5A electrode, a G5B electrode, a G5C electrode and a G6 electrode). The electron beam focusing portion includes a first focus adjusting lens portion for varying a diverging angle of the electron beams likewise in both of a horizontal direction and a vertical direction and a second focus adjusting lens portion capable of making a focus adjustment of the electron beams independently of the first focus adjusting lens portion. Accordingly, it is possible to adjust various kinds of focus states with a single kind of structure of the electron gun.

### BACKGROUND OF THE INVENTION

1. Field of the Invention

The present invention relates to a cathode ray tube. In particular, the present invention relates to a cathode ray tube including an electron gun capable of adjusting a focus state of electron beams arbitrarily.

2. Description of Related Art

FIG. 10 is a sectional view showing a configuration of a conventional cathode ray tube 100. As shown in FIG. 10, a cathode ray tube generally has an envelope formed of a panel 101 and a funnel 102 joined as one piece with this panel 101. On an inner surface of the panel 101, a phosphor screen 103 (target) formed of a striped or dotted tricolor phosphor layer emitting light of blue (B), green (G) and red (R) colors is formed. A shadow mask 104 with a large number of apertures (small holes) is provided so as to face the phosphor screen 103. Inside a neck portion 102a of the funnel 102, an electron gun 106 for emitting three electron beams 105B, 105G and 105R is provided. The three electron beams 105B, 105G and 105R emitted from the electron gun 106 are deflected by horizontal and vertical deflection magnetic fields generated from a deflection yoke 107 mounted outside the funnel 102 and collide with predetermined phosphors in the phosphor screen 103 via the shadow mask 104. In this manner, the phosphors emit light, thus displaying a color image.

FIG. 11 is a sectional view showing the electron gun 106 mounted in the conventional cathode ray tube 100. As shown in FIG. 11, the conventional electron gun 106 includes an electron beam generating portion 108 and an electron beam focusing portion 109. The electron beam generating portion 108 includes cathodes K, a G1 electrode and a G2 electrode that are disposed in this order toward the phosphor screen. The electron beam focusing portion 109 includes a G3 electrode, a G4 electrode, a G5B electrode, a G5C electrode and a G6 electrode that are disposed in this order from the G2 electrode toward the phosphor screen.

This conventional electron gun 106 has a structure as follows. Horizontal-vertical electron beam asymmetry generated by a final main focusing lens formed by the G5C electrode and the G6 electrode is corrected by a non-axisymmetric lens formed between the G5B electrode and the G5C electrode. At the same time, a parabolic dynamic voltage synchronized with deflection is superposed and applied onto the G5C electrode. In this way, the focus of the electron beam substantially is achieved over the entire phosphor screen 103. It is noted that the above-noted electron beam asymmetry may be positive astigmatism generated because a vertical focusing power is weaker than a horizontal focusing power or negative astigmatism generated because the vertical focusing power is stronger than the horizontal focusing power.

In the cathode ray tube 100 including such an electron gun 106, the size of the cathode ray tube 100, the ability of the electron gun 106 and the like uniquely determine the ability of an image to be displayed (focus performance).

In other words, in the case of the electron gun 106 described above, the final main focusing lens alone can focus an electron beam spot only in the horizontal or vertical direction. Thus, the non-axisymmetric lens formed between the G5B electrode and the G5C electrode also is operated as described above, thereby allowing the beam spot to be just in focus both in the horizontal and vertical directions. At this time, since the electric potentials of the G5B electrode and the G5C electrode are determined uniquely according to the operation of the non-axisymmetric lens, the focus performance of the electron gun also is determined uniquely.

Examples of such an electron gun include a dynamic-focus-type electron gun having a single non-axisymmetric lens disclosed in JP 61(1986)-099249 A and a dynamic-focus-type electron gun with a double quadrupole lens having two non-axisymmetric lenses disclosed in JP 11(1999)-345576 A.

However, because the focus performance is determined uniquely depending on the size of the cathode ray tube in which the electron gun is to be mounted, there has been a problem that the electron gun has to be designed individually according to the size of each cathode ray tube.

For example, when an electron gun with a size for a small cathode ray tube is mounted in a large cathode ray tube, the distance that an electron beam emitted from the electron gun travels to the phosphor screen becomes greater, so that the spot size of the electron beam increases. In order to improve this, it conventionally has been necessary to change the design of the electron gun, for example, reduce the diameter of the apertures for passing electron beams in the G1 electrode and the G2 electrode in the electron beam generating portion or increase the length of the electron gun.

Conversely, when an electron gun with a size for a large cathode ray tube is mounted in a small cathode ray tube, the electron beam spot becomes so small that moiré is generated in a peripheral portion of the screen. In order to improve this, it conventionally has been necessary to change the design of the electron gun, for example, increase the diameter of the apertures for passing electron beams in the G1 electrode and the G2 electrode in the electron beam generating portion or reduce the length of the electron gun.

Further, a cathode ray tube is put in a TV set or the like for commercialization, and one manufacturer of TV sets sometimes prefers a different focus state from the other. Accordingly, it has been necessary to change the focus state for each manufacturer, and the design of the electron gun sometimes has to be changed.

Changing the design of the electron gun as described above has involved problems of increasing personnel costs for those who are engaged in the design change, costs for producing several kinds of components for focus control, and further costs for production molds necessary for each component of various kinds.

### SUMMARY OF THE INVENTION

It is an object of the present invention to provide an electron gun that can adjust various kinds of focus states with a single kind of structure and can be produced at low cost.

A cathode ray tube according to the present invention includes a panel whose inner surface is provided with a screen, a funnel that is joined to the panel, an electron gun received in a neck portion of the funnel, and a stem having a pin for supplying a predetermined voltage to an electrode constituting the electron gun. The electron gun includes an electron beam generating portion including at least a cathode, a G1 electrode and a G2 electrode that are provided in this order toward the screen and an electron beam focusing portion for focusing an electron beam generated in the electron beam generating portion onto the screen. The electron beam focusing portion includes a first focus adjusting lens portion for varying a diverging angle of the electron beam likewise in both of a horizontal direction and a vertical direction and a second focus adjusting lens portion capable of making a focus adjustment of the electron beam independently of the first focus adjusting lens portion.

### BRIEF DESCRIPTION OF THE DRAWINGS

FIG. 1(A) is a sectional view showing a configuration of a cathode ray tube according to each embodiment of the present invention, and FIG. 1(B) is a plan view showing a structure of a stem provided in the cathode ray tube.

FIG. 2 is a sectional view showing a structure of an electron gun 6 mounted in a cathode ray tube according to the first embodiment of the present invention.

FIG. 3 is a sectional view showing a structure of an electron gun 6A mounted in a cathode ray tube according to the second embodiment of the present invention.

FIG. 4 is a sectional view showing a structure of an electron gun 6B mounted in a cathode ray tube according to the third embodiment of the present invention.

FIG. 5 is a sectional view showing a structure of an electron gun 6C mounted in a cathode ray tube according to the fourth embodiment of the present invention.

FIG. 6 is a sectional view showing a structure of an electron gun 6D mounted in a cathode ray tube according to the fifth embodiment of the present invention.

FIG. 7 is a sectional view showing a structure of an electron gun 6D′ of a first variation mounted in the cathode ray tube according to the fifth embodiment of the present invention.

FIG. 8 is a sectional view showing a structure of an electron gun 6D″ of a second variation mounted in the cathode ray tube according to the fifth embodiment of the present invention.

FIG. 9 is a sectional view showing a structure of an electron gun 6E mounted in the cathode ray tube according to the sixth embodiment of the present invention.

FIG. 10 is a sectional view showing a configuration of a conventional cathode ray tube.

FIG. 11 is a sectional view showing an electron gun mounted in the conventional cathode ray tube.

### DESCRIPTION OF THE PREFERRED EMBODIMENTS

In accordance with the present invention, it is possible to provide an electron gun that can adjust various kinds of focus states with a single kind of electron gun and can be produced at low cost.

In the cathode ray tube according to an embodiment of the present invention, it is preferable that the electron beam focusing portion includes a G3 electrode disposed adjacent to the G2 electrode in the electron beam generating portion and an anode electrode supplied with an anode voltage. In this case, the G3 electrode preferably is supplied with a first focus voltage from the pin. The first focus voltage is lower than the anode voltage and higher than a voltage applied to the G2 electrode.

Also, in the cathode ray tube according to an embodiment of the present invention, it is preferable that a first focus voltage applied to a predetermined electrode in the first focus adjusting lens portion is adjusted, thereby varying the diverging angle of the electron beam likewise in both of the horizontal direction and the vertical direction and varying a lens power of a prefocus lens formed near the G2 electrode.

Further, in the cathode ray tube according to an embodiment of the present invention, it is preferable that the electron beam focusing portion includes a G3 electrode, a G4 electrode and a G5 electrode that are provided in this order from the G2 electrode in the electron beam generating portion toward the screen and an anode electrode supplied with an anode voltage. In this case, the G3 electrode and the G5 electrode preferably are supplied with a first focus voltage from the pin. The first focus voltage is lower than the anode voltage and higher than a voltage applied to the G2 electrode.

Moreover, in the cathode ray tube according to an embodiment of the present invention, it is preferable that the electron beam focusing portion includes a G3 electrode, a G4 electrode and a G5 electrode that are provided in this order from the G2 electrode in the electron beam generating portion toward the screen. In this case, the G4 electrode preferably is supplied with a first focus voltage from the pin. The first focus voltage is lower than voltages applied to the G3 electrode and the G5 electrode.

Also, in the cathode ray tube according to an embodiment of the present invention, it is preferable that the second focus adjusting lens portion in the electron beam focusing portion includes at least one non-axisymmetric lens and a final main focusing lens.

Furthermore, it is preferable further to include a resistor near the electrode constituting the electron gun, and it is preferable that the final main focusing lens is formed of at least two electrodes consisting of a lower-voltage side electrode and a higher-voltage side electrode that is supplied with an anode voltage and the non-axisymmetric lens is formed of the lower-voltage side electrode of the final main focusing lens and a focusing electrode disposed adjacent to a side of the cathode of the lower-voltage side electrode. In this case, the focusing electrode preferably is supplied with a resistively divided voltage obtained by dividing the anode voltage with the resistor, and the lower-voltage side electrode preferably is supplied with a second focus voltage from the pin.

Moreover, it is preferable that the lower-voltage side electrode further is supplied with a dynamic voltage that varies according to a deflection of the electron beam and is superposed onto the second focus voltage.

Also, it is preferable that the at least two electrodes forming the final main focusing lens include an intermediate electrode supplied with a voltage resistively divided by the resistor.

Additionally, it is preferable that one end of the resistor is connected to a variable resistor element, and the resistively divided voltage is adjusted with the variable resistor element, thereby making the focus adjustment of the electron beam at a center of the screen in the horizontal direction and the vertical direction.

In the above-described cathode ray tube according to each embodiment of the present invention, it is preferable that a unipotential sub-lens is formed in the first focus adjusting lens portion in the electron beam focusing portion.

The following is a description of a cathode ray tube according to an embodiment of the present invention, with reference to the accompanying drawings.

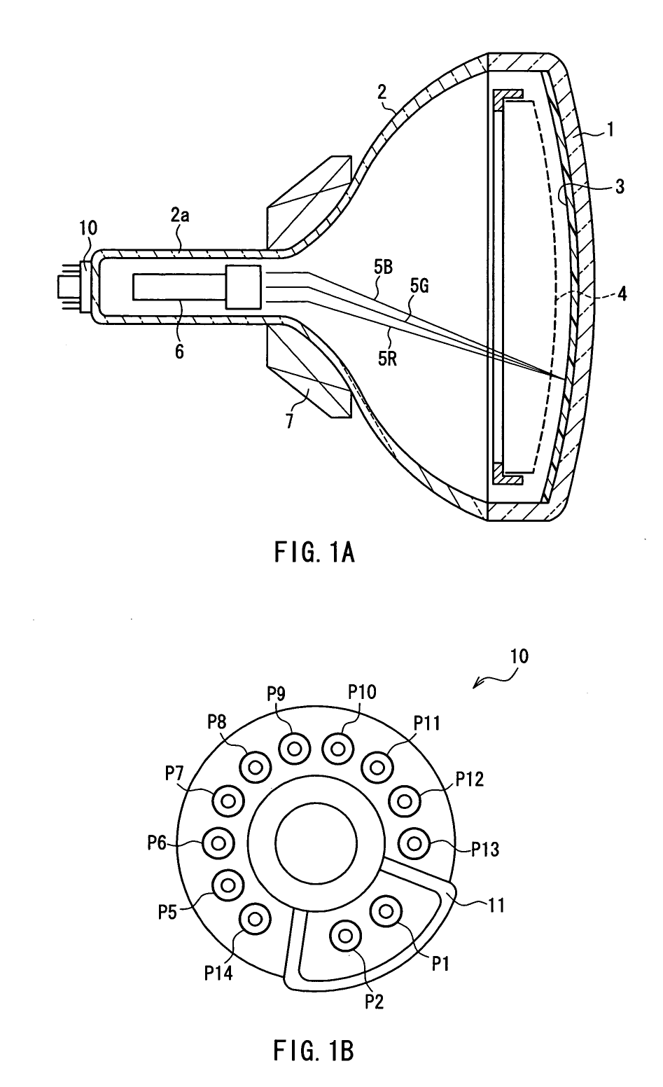

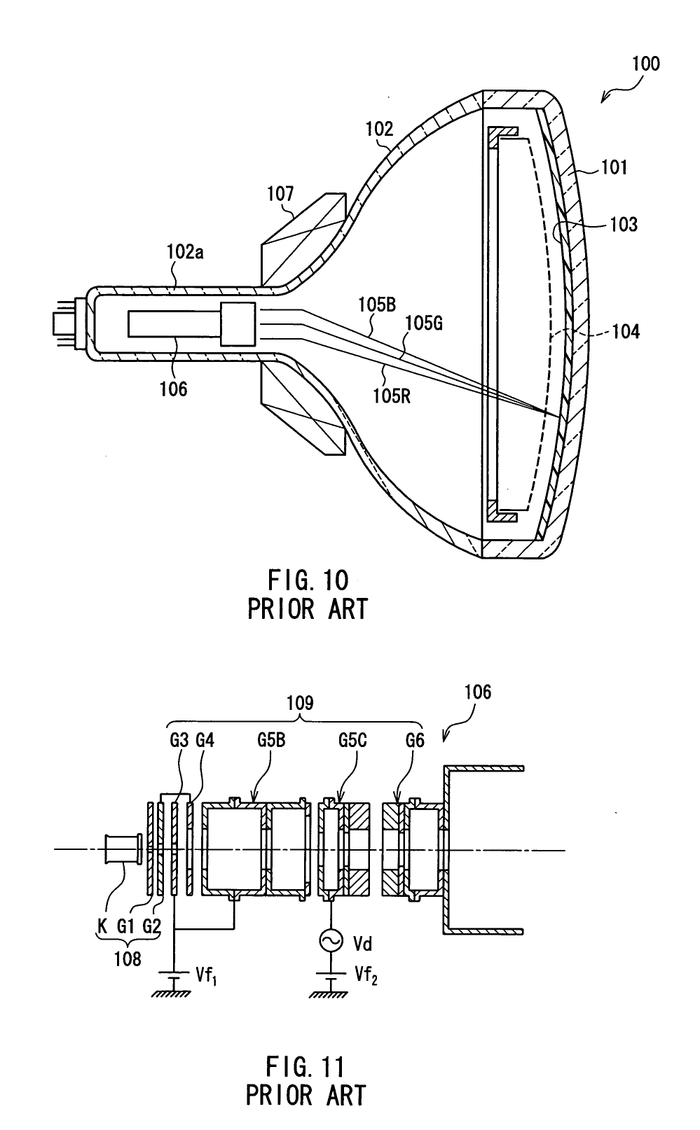

First, a cathode ray tube in accordance with an embodiment of the present invention will be described referring to FIG. 1(A). FIG. 1(A) is a sectional view showing a configuration of the cathode ray tube according to an embodiment of the present invention. A basic structure of the cathode ray tube according to an embodiment of the present invention is the same as that of the cathode ray tube shown in FIG. 10. In other words, the cathode ray tube has an envelope formed of a panel 1 and a funnel 2 joined as one piece with this panel 1. On an inner surface of the panel 1, a phosphor screen 3 formed of a striped or dotted tricolor phosphor layer emitting light of blue (B), green (G) and red (R) colors is formed. A shadow mask 4 with a large number of apertures (small holes) is provided so as to face the phosphor screen 3. Inside a neck portion 2a of the funnel 2, an electron gun 6 for emitting three electron beams 5B, 5G and 5R is received. The three electron beams 5B, 5G and 5R emitted from the electron gun 6 are deflected by horizontal and vertical deflection magnetic fields generated from a deflection yoke 7 mounted outside the funnel 2 and collide with predetermined phosphors in the phosphor screen 3 via the shadow mask 4. In this manner, the phosphors emit light, thus displaying a color image.

Now, the following is a description of the structure of an electron gun according to each embodiment described below that is mounted in the above-described cathode ray tube of the present invention.

### First Embodiment

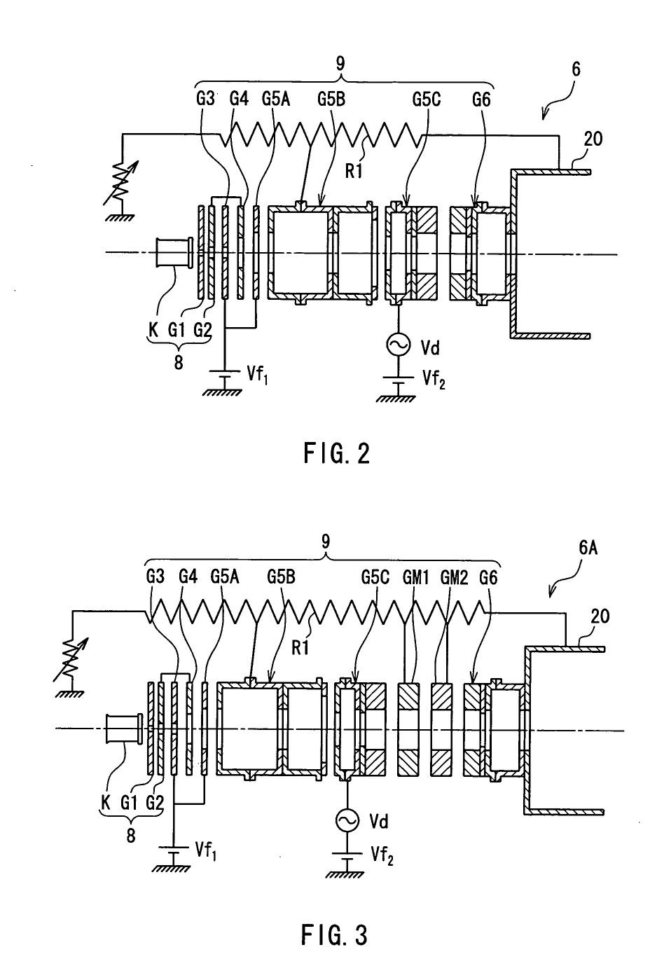

FIG. 2 is a sectional view showing the structure of the electron gun 6 provided in the cathode ray tube according to the first embodiment. As shown in FIG. 2, the electron gun 6 includes an electron beam generating portion 8 and an electron beam focusing portion 9. The electron beam generating portion 8 includes cathodes K, a G1 electrode and a G2 electrode that are disposed in this order toward the phosphor screen. As the cathodes K, three cathodes are provided along an in-line direction. In the present invention, the in-line direction along which these three cathodes are aligned is referred to as a horizontal direction or a transverse direction, whereas a direction perpendicular to the in-line direction and a tube axis is referred to as a vertical direction or an upright direction. The electron beam focusing portion 9 includes a G3 electrode, a G4 electrode, a G5A electrode, a G5B electrode (a focusing electrode), a G5C electrode (a lower-voltage side electrode) and a G6 electrode (a higher-voltage side electrode) that are disposed in this order from the G2 electrode toward the phosphor screen. The G6 electrode is provided with a convergence cup 20. These members of the electron gun are supported and fixed by a pair of insulating supports (not shown). Further, near the electrodes constituting the electron gun 6, a resistor R1 is provided, with its one end connected to the G6 electrode and the other end grounded via a variable resistor provided outside the tube. Incidentally, a ground also may be established directly without using the variable resistor.

Next, the shape of individual electrodes constituting the electron gun will be described.

The G1 electrode is a thin plate-like electrode and provided with three electron beam passing apertures having a small diameter (for example, circular apertures having a diameter of about 0.30 to 0.70 mm).

The G2 electrode also is a thin plate-like electrode similar to the G1 electrode and provided with three electron beam passing apertures having a diameter equal to or slightly larger than that of the G1 electrode (for example, circular apertures having a diameter of about 0.35 to 0.80 mm).

The G3 electrode also is a plate-like electrode and provided with three electron beam passing apertures having a diameter slightly larger than that of the G2 electrode (for example, circular apertures having a diameter of about 0.8 to 1.5 mm). The distance between the G2 electrode and the G3 electrode is set to be equal to or smaller than 1 mm so that a voltage applied to the G3 electrode has a large influence.

The G4 electrode and the G5A electrode also are plate-like electrodes and provided with relatively large electron beam passing apertures (for example, circular apertures having a diameter of about 1.5 to 6.0 mm).

The G5B electrode is constituted by three cup-like electrodes and a plate-like electrode. The surface facing the G5A electrode is provided with three electron beam passing apertures having a diameter equal to or slightly larger than that of the G5A electrode (for example, circular apertures having a diameter of about 3.0 to 6.0 mm). The surface facing the G5C electrode is provided with three vertically-elongated electron beam passing apertures (for example, horizontal dimension/vertical dimension=5.0 mm/7.0 mm).

The G5C electrode is constituted by cup-like electrodes whose open ends are abutted, a thin plate-like electrode and a thick plate-like electrode that are formed as one piece. The G5B electrode side surface of the cup-like electrode facing the G5B electrode is provided with three horizontally-elongated electron beam passing apertures (for example, horizontal dimension/vertical dimension=6.0 mm/5.0 mm). The thick plate-like electrode facing the G6 electrode is provided with three electron beam passing apertures having a large diameter (for example, circular apertures having a diameter of about 6.0 mm). The thin plate-like electrode sandwiched between the thick plate-like electrode and the cup-like electrode is provided with three horizontally-elongated electron beam passing apertures (for example, horizontal dimension/vertical dimension=6.0 mm/5.0 mm).

Similarly to the G5C electrode, the G6 electrode is constituted by a thick plate-like electrode, a thin plate-like electrode and cup-like electrodes whose open ends are abutted that are formed as one piece. The thick plate-like electrode facing the G5C electrode is provided with three electron beam passing apertures having a large diameter (for example, circular apertures having a diameter of about 6.0 mm). The thin plate-like electrode sandwiched between the thick plate-like electrode and the cup-like electrode is provided with three horizontally-elongated electron beam passing apertures (for example, horizontal dimension/vertical dimension=6.0 mm/5.0 mm).

As shown in FIG. 1(A), an end portion of the neck portion 2a of the funnel 2 is provided with a stem 10 having pins for supplying predetermined voltages to the electrodes constituting the above-described electron gun 6. FIG. 1(B) is a plan view showing the structure of the stem 10. As shown in FIG. 1(B), the stem 10 is provided with a wall portion 11. Inside the wall portion 11, a first focus pin P1 and a second focus pin P2 are provided. The first focus pin P1 applies a predetermined first focus voltage to the G3 electrode and the G5A electrode, and the second focus pin P2 applies a predetermined second focus voltage and a dynamic voltage to the G5C electrode. In an outer region of the wall portion 11, pins P5 to P14 are provided for applying predetermined voltages to the G1 electrode, the G2 electrode, the G4 electrode, the three cathodes K corresponding to the three electron beams and heaters for the cathodes K etc.

The following description is directed to the relationship of voltages to be applied to the electrodes constituting the electron gun, with reference to FIG. 2.

The G1 electrode is supplied with a ground voltage or a negative voltage. The G2 electrode and the G4 electrode are connected electrically inside the tube and supplied with an accelerating voltage (V2) with a low potential of about 300 to 800 V. The G3 electrode and the G5A electrode are connected electrically inside the tube and supplied with a constant first focus voltage (Vf1) of about 4 to 12 kV (about 15% to 40% of an anode voltage). The G5C electrode is supplied with a dynamic focus voltage (Vf2+Vd) obtained by superposing a parabolic AC dynamic voltage (Vd: about 1000 V) synchronized with deflection onto a second focus voltage (Vf2) of about 6 to 9 kV (about 25% of an anode voltage). The G6 electrode is supplied with an anode voltage (Va) of about 25 to 30 kV supplied from outside of the cathode ray tube. The G5B electrode is connected electrically to the resistor R1 via a voltage supply terminal provided in an intermediate portion of the resistor R1. The G5B electrode is supplied with a resistively divided voltage obtained by dividing the anode voltage with the resistor R1. The G5B electrode is supplied with a voltage substantially as high as the voltage applied to the G5C electrode. Although the G5B electrode is supplied with the resistively divided voltage from the resistor R1 here because the mainstream of the stem in cathode ray tubes currently is of a two-pin system (a system including two pins, i.e., the first focus pin P1 and the second focus pin P2, as pins capable of supplying a middle voltage) as shown in FIG. 1(B), it is not always necessary to apply a resistively divided voltage. For example, if the stem has three or more pins capable of supplying a middle voltage, a predetermined voltage may be applied to the G5B electrode from these pins of the stem.

Now, the effects of the cathode ray tube according to the present embodiment will be discussed.

With the above-described structure of the electron gun, a lens power of a prefocus lens generated between the G2 electrode and the G3 electrode and a lens power of a unipotential sub-lens generated by the G3 electrode, the G4 electrode and the G5A electrode are adjusted freely by varying the first focus voltage alone. In other words, in a first focus adjusting lens portion where electron lenses such as the prefocus lens and the unipotential sub-lens are generated, simply by varying the first focus voltage alone regardless of the second focus voltage, it is possible to adjust the electron lens powers of the prefocus lens and the unipotential sub-lens freely. Thus, simply by varying the first focus voltage alone, it is possible both to vary a diverging angle of the electron beams emitted from the electron beam generating portion likewise in both of the horizontal direction and the vertical direction in the first focus adjusting lens portion and to vary an electric potential distribution near the G2 electrode freely. Here, varying the diverging angle of the electron beams likewise in both of the horizontal direction and the vertical direction means that, when the diverging angle of the electron beams increases (or decreases) in the horizontal direction, it also increases (or decreases) in the vertical direction.

Furthermore, the beam spot is set to be just in focus in the horizontal direction and the vertical direction by adjusting the lens power of two lenses, i.e., a quadrupole lens (a non-axisymmetric lens) and the final main focusing lens. The quadrupole lens is generated between the G5C electrode supplied with the second focus voltage and the G5B electrode supplied with the resistively divided voltage obtained by dividing the anode voltage with the resistor, and the final main focusing lens is generated between the G5C electrode and the G6 electrode. In other words, the lens power of the non-axisymmetric lens generated between the G5B electrode and the G5C electrode can be adjusted by varying a variable resistor element connected to one end of the resistor R1 so as to adjust the resistively divided voltage to be applied to the G5B electrode, and the lens power of the final main focusing lens can be adjusted by adjusting the second focus voltage, so that the focus of the electron beams at the center of the screen can be adjusted in the horizontal direction and the vertical direction.

With the structure of the electron gun as described in the present embodiment, the focus of the electron beams can be adjusted in the second focus adjusting lens portion where the non-axisymmetric lens and the final main focusing lens are generated, independently of the first focus adjusting lens portion where the prefocus lens and the unipotential sub-lens are generated. In other words, regardless of how the first focus voltage is set, simply by adjusting the second focus voltage, the electron lens powers of the non-axisymmetric lens and the final main focusing lens can be adjusted freely.

In this manner, it is possible to allow the electron beam spot to be just in focus at the center of the screen in both of the horizontal direction and the vertical direction. It is noted that the first focus voltage is used to vary an overall focus level.

For example, raising the first focus voltage increases the lens power of the prefocus lens generated between the G2 electrode and the G3 electrode, which increases a voltage that permeates from the G3 electrode near the G2 electrode. Accordingly, it is possible to raise the electric potential at an object point, thereby reducing an object point diameter. In this case, owing to the increase in the lens power of the prefocus lens, the diverging angle of the electron beams decreases both in the horizontal direction and the vertical direction. Also, since the lens power of the unipotential sub-lens generated by the G3 electrode, the G4 electrode and the G5A electrode increases, the diverging angle of the electron beams decreases both in the horizontal direction and the vertical direction. Consequently, the electron beams become unlikely to be affected by an aberration component of the final main focusing lens, so that it is possible to reduce the electron beam spot size on the phosphor screen.

Conversely, lowering the first focus voltage causes a phenomenon that is opposite to the above, so that the size of the electron beam spot on the phosphor screen increases.

As described above, with the electron gun according to the present embodiment, a cathode ray tube can achieve the increased or reduced size of the electron beam spot on the phosphor screen simply by controlling the first focus voltage alone, so that an overall focus level can be adjusted easily. Thus, in the case of mounting the cathode ray tube in a TV set or the like, it is possible to set a focus level according to the preference of each TV set manufacturer. For example, for a manufacturer that is sensitive to moiré generation, the first focus voltage is set to be low, thereby obtaining an excellent image free from moiré while tolerating the focus state slightly. On the other hand, for a manufacturer that is sensitive to the focus state, the first focus voltage is set to be relatively high, thereby obtaining an excellent image with a good focus.

Moreover, in the case of mounting the electron gun according to the present embodiment in cathode ray tubes with different sizes, since the first focus adjusting lens portion and the second focus adjusting lens portion are capable of making focus adjustment independently of each other, the same electron gun can be mounted in a large cathode ray tube and a small cathode ray tube. For example, in the case of mounting the electron gun in a large cathode ray tube, the first focus voltage is set to be high, thereby raising the focus level. In the case of mounting it in a small cathode ray tube, the first focus voltage is set to be low, thereby lowering the focus level.

In this manner, the electron gun to be mounted in the cathode ray tube according to the present embodiment can adjust various kinds of focus states with a single kind of electron gun. Therefore, it is not necessary to change the design of the electron gun, which is usually necessary in accordance with the difference in size of the cathode ray tubes and the different demands of individual TV set manufacturers. Consequently, it also is possible to achieve an effect of suppressing an increase in costs accompanying the change in the design of the electron gun.

### Second Embodiment

FIG. 3 is a sectional view showing a structure of an electron gun 6A mounted in a cathode ray tube according to the second embodiment. The same elements as those in the electron gun 6 in the first embodiment shown in FIG. 2 are assigned the same reference numerals, and the detailed description thereof will be omitted.

The electron gun 6A according to the second embodiment is different from the electron gun 6 according to the first embodiment in that it includes two plate-like intermediate electrodes GM1 and GM2 between the G5C electrode and the G6 electrode as shown in FIG. 3. In other words, the electron gun 6A according to the present embodiment aims to increase a lens aperture by forming the final main focusing lens to be an electric field expansion type.

The intermediate electrodes GM1 and GM2 respectively are connected to the resistor R1 and supplied with a divided voltage from the resistor R1. For example, the intermediate electrodes GM1 and GM2 are supplied with voltages of about 40% and about 65% of the anode voltage, respectively.

With this structure, the lens aperture of the final main focusing lens substantially can be increased. Furthermore, in addition to the effect achieved by the electron gun 6 of the first embodiment, the electron gun 6A according to the second embodiment can achieve the following effect.

That is, in the case of using the electric-field expansion type final main focusing lens by providing the intermediate electrodes GM1 and GM2 in the conventional electron gun (see FIG. 11), an increase in the aperture of the final main focusing lens weakens the lens power with respect to the electron beams, causing a problem that this weakening has to be compensated for by reducing the voltage for bringing the electron beam just into focus on the phosphor screen, namely, the second focus voltage. In order to reduce the second focus voltage, a voltage applied to the G5B electrode for determining the non-axisymmetric lens has to be lowered, so that the electric potential of the G3 electrode connected to the G5B electrode also has to be lowered. This lowers the electric potential near the G2 electrode that is adjacent to the G3 electrode, reducing the electric potential at the object point, leading to focus deterioration. More specifically, in a conventional electron gun where there is no intermediate electrode GM1 or GM2, the second focus voltage is about 30% of the anode voltage. However, when two intermediate electrodes are provided and supplied respectively with voltages 40% and 65% of the anode voltage, the second focus voltage sometimes has to be lowered to about 20% of the anode voltage.

In contrast, according to the electric-field expansion type electron gun 6A according to the present embodiment shown in FIG. 3, since the first focus adjusting lens portion around the G3 electrode and the second focus adjusting lens portion for generating the non-axisymmetric lens can make a focus adjustment independently of each other, it is possible to adjust the first focus voltage to be applied to the G3 electrode independently of the second focus voltage. Thus, in the case where the second focus voltage is lowered to about 20% of the anode voltage, for example, the first focus voltage to be applied to the G3 electrode can be set to a desired value such as a value about 30% of the anode voltage.

Thus, with the electric-field expansion type electron gun using the intermediate electrodes GM1 and GM2, it also is possible to maintain an excellent focus quality in addition to the effect of the first embodiment.

### Third Embodiment

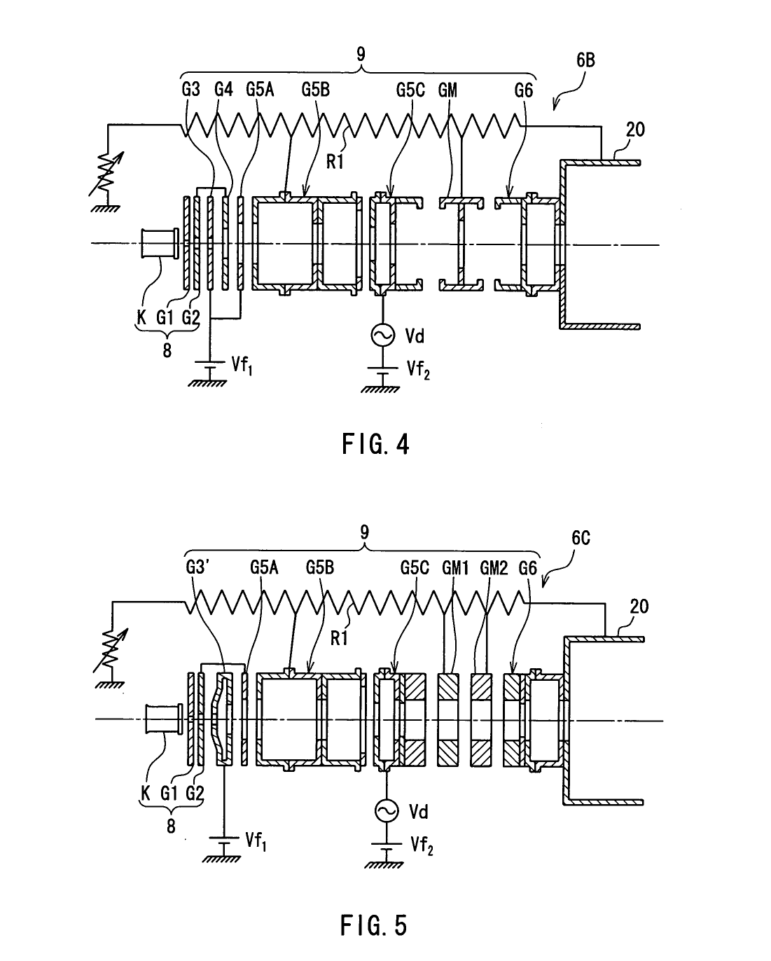

FIG. 4 is a sectional view showing a structure of an electron gun 6B mounted in a cathode ray tube according to the third embodiment. The same elements as those in the electron gun 6 in the first embodiment shown in FIG. 2 are assigned the same reference numerals, and the detailed description thereof will be omitted.

The electron gun 6B according to the third embodiment is different from the electron gun 6 according to the first embodiment in that it includes a tubular intermediate electrode GM having a correction electrode plate therein between the G5C electrode and the G6 electrode as shown in FIG. 4. In other words, the electron gun 6B according to the present embodiment aims to increase a lens aperture by forming the final main focusing lens to be an electric field expansion type.

The intermediate electrode GM has a single opening common to the three electron beams on each of the G5C electrode side and the G6 electrode side. Also, inside the intermediate electrode GM, the correction electrode plate provided with three electron beam passing apertures is disposed. The intermediate electrode GM is connected to the resistor R1 and supplied with a middle voltage between the G5C electrode and the G6 electrode from the resistor R1.

A cathode ray tube including the electron gun 6B according to the present embodiment also can achieve an effect similar to the cathode ray tube including the electron gun 6A according to the second embodiment described above. In other words, since it is possible not only to increase the aperture of the final main focusing lens substantially but also to allow the first focus adjusting lens portion around the G3 electrode and the second focus adjusting lens portion for generating the non-axisymmetric lens to make a focus adjustment independently of each other, an excellent focus quality can be maintained.

### Fourth Embodiment

FIG. 5 is a sectional view showing a structure of an electron gun 6C mounted in a cathode ray tube according to the fourth embodiment. The same elements as those in the electron gun 6A in the second embodiment shown in FIG. 3 are assigned the same reference numerals, and the detailed description thereof will be omitted.

The electron gun 6C according to the fourth embodiment is different from the electron gun 6A according to the second embodiment in that it includes a G3′ electrode to be supplied with the first focus voltage having a structure shown in FIG. 5, thereby omitting an electrode corresponding to the G4 electrode shown in FIG. 3 and connecting the G5A electrode and the G2 electrode.

The G3′ electrode has a G2 side surface provided with three electron beam passing apertures with a small diameter and a G5B side surface provided with three electron beam passing apertures with a large diameter.

In a cathode ray tube including the electron gun 6C according to the present embodiment, a sub-lens generated by the G3′ electrode and the G5A electrode is not a unipotential lens but an electron lens capable of varying the diverging angle of the electron beam likewise in both of the horizontal direction and the vertical direction. Since the lens power of the above-noted sub-lens can be adjusted simply by changing the first focus voltage, it is easy to adjust the focus characteristics, so that an effect similar to the above-described cathode ray tube including the electron gun 6A in the second embodiment can be achieved. In other words, it is possible not only to increase the aperture of the final main focusing lens substantially but also to allow the first focus adjusting lens portion around the G3′ electrode and the second focus adjusting lens portion for generating the non-axisymmetric lens to make a focus adjustment independently of each other, an excellent focus quality can be maintained.

### Fifth Embodiment

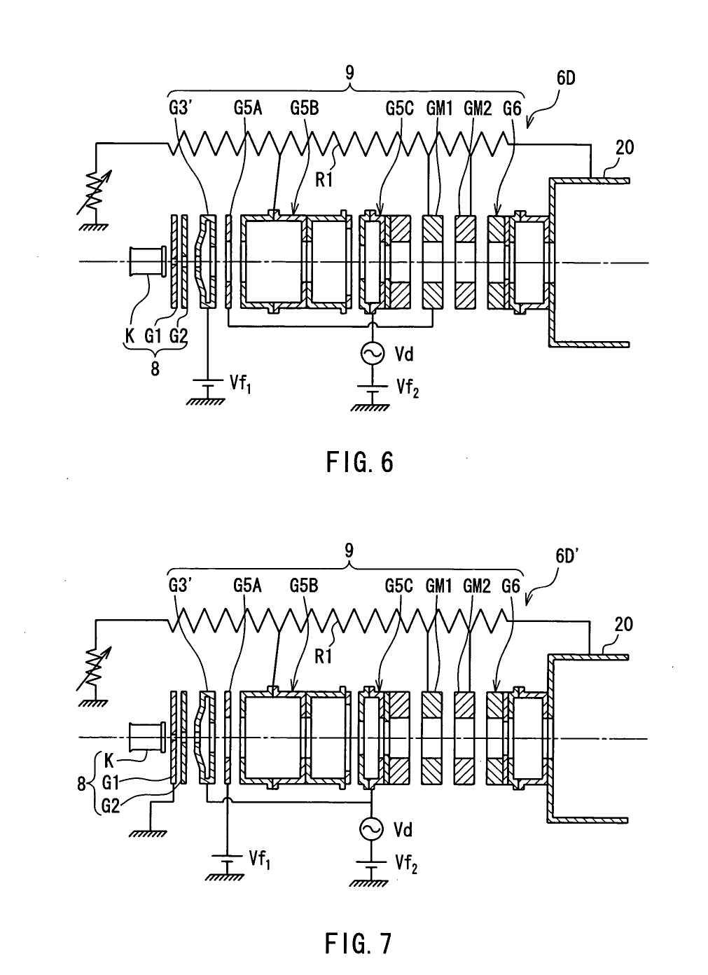

FIG. 6 is a sectional view showing a structure of an electron gun 6D mounted in a cathode ray tube according to the fifth embodiment. The same elements as those in the electron gun 6C in the fourth embodiment shown in FIG. 5 are assigned the same reference numerals, and the detailed description thereof will be omitted.

The electron gun 6D according to the fifth embodiment is different from the electron gun 6C according to the fourth embodiment in the following respect. That is, the G5A electrode is connected electrically to the G2 electrode in the electron gun 6C according to the fourth embodiment, whereas the G5A electrode is connected electrically to an intermediate electrode GM1 in the electron gun 6D according to the present embodiment.

In a cathode ray tube including the electron gun 6D according to the present embodiment, although a voltage applied to the G5A electrode is determined uniquely by the electrode GM1 in the second focus adjusting lens portion, the lens power of the sub-lens generated between the G3′ electrode and the G5A electrode can be adjusted simply by varying the first focus voltage applied to the G3′ electrode. Therefore, it is easy to adjust the focus characteristics, so that an effect similar to the above-described cathode ray tube including the electron gun 6C in the fourth embodiment can be achieved. In other words, it is possible not only to increase the aperture of the final main focusing lens substantially but also to allow the first focus adjusting lens portion around the G3′ electrode and the second focus adjusting lens portion for generating the non-axisymmetric lens to make a focus adjustment independently of each other, an excellent focus quality can be maintained.

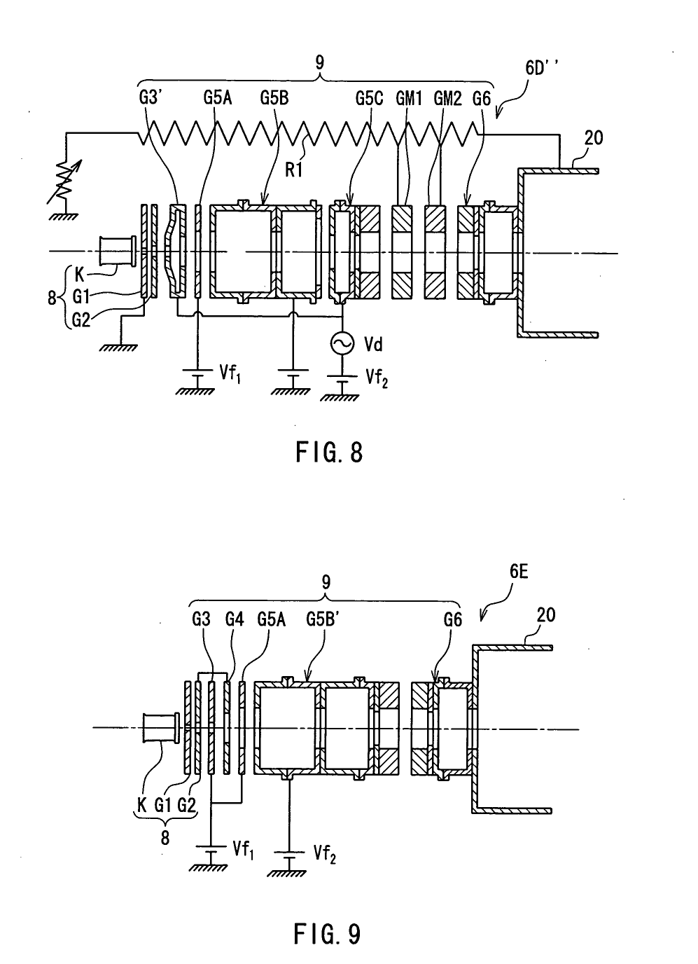

FIGS. 7 and 8 are sectional views respectively showing the structure of electron guns 6D′ and 6D″ of a variation of the present embodiment. The same elements as those in the electron gun 6D shown in FIG. 6 are assigned the same reference numerals, and the detailed description thereof will be omitted.

In each of the electron guns 6D′ and 6D″, the G3′ electrode is connected electrically to the G5C electrode, whereby the G3′ electrode also is supplied with a dynamic focus voltage as shown in FIGS. 7 and 8. Further, the G5A electrode is supplied with a predetermined first focus voltage from a pin of the stem or the like. The voltage to be applied to the G5B electrode is the resistively divided voltage from the resistor R1 in the case of the electron gun 6D′ and the voltage supplied from the pin of the stem in the case of the electron gun 6D″.

In the electron guns 6D′ and 6D″, the first focus voltage applied to the G5A electrode is varied, thereby operating the front and rear unipotential lenses, so that the diverging angle of the electron beams can be adjusted to be alike in both of the horizontal direction and the vertical direction. Moreover, since the lens power can be adjusted simply by varying the first focus voltage, it is easy to adjust the focus characteristics, so that an effect similar to the cathode ray tube including the electron gun 6D can be achieved. In other words, since it is possible not only to increase the aperture of the final main focusing lens substantially but also to allow the first focus adjusting lens portion around the G3′ electrode and the second focus adjusting lens portion for generating the non-axisymmetric lens to make a focus adjustment independently of each other, an excellent focus quality can be maintained.

### Sixth Embodiment

FIG. 9 is a sectional view showing a structure of an electron gun 6E mounted in a cathode ray tube according to the sixth embodiment. The same elements as those in the electron gun 6 in the first embodiment shown in FIG. 2 are assigned the same reference numerals, and the detailed description thereof will be omitted.

The electron gun 6E according to the sixth embodiment is different from the electron gun 6 according to the first embodiment in the following respect. That is, in the electron gun 6E in the sixth embodiment, the G5B electrode and the G5C electrode in the electron gun 6 in the first embodiment shown in FIG. 2 are formed into one piece as a G5B′ electrode, and this G5B′ electrode is supplied with the second focus voltage Vf2 without superposing the dynamic voltage. Further, although whether the resistor R1 is provided can be determined arbitrarily, no resistor R1 is provided in the present embodiment.

The G5B′ electrode is constituted by two pairs of four cup-like electrodes whose open ends are abutted, a thin plate-like electrode and a thick plate-like electrode that are formed as one piece. Bottom surfaces of the four cup-like electrodes including the surface facing the G5A electrode are provided with three electron beam passing apertures having a diameter equal to or larger than that of the G5A electrode (for example, circular apertures having a diameter of about 3.0 to 6.0 mm). The thin plate-like electrode sandwiched between the cup-like electrode and the thick plate-like electrode is provided with three horizontally-elongated electron beam passing apertures (for example, horizontal dimension/vertical dimension=6.0 mm/5.0 mm). The thick plate-like electrode facing the G6 electrode is provided with three electron beam passing apertures (for example, circular apertures having a diameter of about 6.0 mm).

Although the electron gun 6E according to the present embodiment is not a dynamic-focus-type electron gun, a cathode ray tube including the electron gun 6E of the present embodiment can achieve an effect similar to the cathode ray tube including the above-noted dynamic-focus-type electron gun. In other words, the lens power of the prefocus lens generated between the G2 electrode and the G3 electrode and the lens power of the unipotential sub-lens generated by the G3 electrode, the G4 electrode and the G5A electrode can be adjusted simply by varying the first focus voltage applied to the G3 electrode. This makes it possible to vary the diverging angle of the electron beams likewise in both of the horizontal direction and the vertical direction. Further, the second focus voltage is changed, thereby making a focus adjustment in the second focus adjusting lens portion where the final main focusing lens is generated, independently of the first focus adjusting lens portion.

In the second to sixth embodiments described above, similarly to the first embodiment, it is not necessary to change the design of the electron gun, which is usually necessary in accordance with the difference in size of the cathode ray tubes and the different demands of individual TV set manufacturers. Consequently, an increase in costs accompanying the change in the design of the electron gun can be suppressed.

The present invention can be applied to a cathode ray tube capable of controlling a focus state arbitrarily.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. A cathode ray tube comprising:
a panel whose inner surface is provided with a screen;
a funnel that is joined to the panel;
an electron gun received in a neck portion of the funnel; and
a stem having a pin for supplying a predetermined voltage to an electrode constituting the electron gun;
wherein the electron gun comprises an electron beam generating portion including at least a cathode, a G1 electrode and a G2 electrode that are provided in this order toward the screen and an electron beam focusing portion for focusing an electron beam generated in the electron beam generating portion onto the screen, and
the electron beam focusing portion comprises a first focus adjusting lens portion for varying a diverging angle of the electron beam likewise in both of a horizontal direction and a vertical direction and a second focus adjusting lens portion capable of making a focus adjustment of the electron beam independently of the first focus adjusting lens portion.

2. The cathode ray tube according to claim 1, wherein the electron beam focusing portion comprises a G3 electrode disposed adjacent to the G2 electrode in the electron beam generating portion and an anode electrode supplied with an anode voltage, and
the G3 electrode is supplied with a first focus voltage from the pin, the first focus voltage being lower than the anode voltage and higher than a voltage applied to the G2 electrode.

3. The cathode ray tube according to claim 1, wherein a first focus voltage applied to a predetermined electrode in the first focus adjusting lens portion is adjusted, thereby varying the diverging angle of the electron beam likewise in both of the horizontal direction and the vertical direction and varying a lens power of a prefocus lens formed near the G2 electrode.

4. The cathode ray tube according to claim 1, wherein the electron beam focusing portion comprises a G3 electrode, a G4 electrode and a G5 electrode that are provided in this order from the G2 electrode in the electron beam generating portion toward the screen and an anode electrode supplied with an anode voltage, and
the G3 electrode and the G5 electrode are supplied with a first focus voltage from the pin, the first focus voltage being lower than the anode voltage and higher than a voltage applied to the G2 electrode.

5. The cathode ray tube according to claim 1, wherein the electron beam focusing portion comprises a G3 electrode, a G4 electrode and a G5 electrode that are provided in this order from the G2 electrode in the electron beam generating portion toward the screen, and the G4 electrode is supplied with a first focus voltage from the pin,
the first focus voltage being lower than voltages applied to the G3 electrode and the G5 electrode.

6. The cathode ray tube according to claim 1, wherein the second focus adjusting lens portion in the electron beam focusing portion comprises at least one non-axisymmetric lens and a final main focusing lens.

7. The cathode ray tube according to claim 6, further comprising a resistor near the electrode constituting the electron gun,
wherein the final main focusing lens is formed of at least two electrodes consisting of a lower-voltage side electrode and a higher-voltage side electrode that is supplied with an anode voltage,
the non-axisymmetric lens is formed of the lower-voltage side electrode of the final main focusing lens and a focusing electrode disposed adjacent to a side of the cathode of the lower-voltage side electrode, and
the focusing electrode is supplied with a resistively divided voltage obtained by dividing the anode voltage with the resistor, and the lower-voltage side electrode is supplied with a second focus voltage from the pin.

8. The cathode ray tube according to claim 7, wherein the lower-voltage side electrode further is supplied with a dynamic voltage that varies according to a deflection of the electron beam and is superposed onto the second focus voltage.

9. The cathode ray tube according to claim 7, wherein the at least two electrodes forming the final main focusing lens comprise an intermediate electrode supplied with a voltage resistively divided by the resistor.

10. The cathode ray tube according to claim 7, wherein one end of the resistor is connected to a variable resistor element, and the resistively divided voltage is adjusted with the variable resistor element, thereby making the focus adjustment of the electron beam at a center of the screen in the horizontal direction and the vertical direction.

11. The cathode ray tube according to claim 1, wherein a unipotential sub-lens is formed in the first focus adjusting lens portion in the electron beam focusing portion.
